(19) United States
(12) Patent Application Publication
(10) Pub. No.: US 2016/0013990 A1
(43) Pub. Date: Jan. 14, 2016

(54) NETWORK TRAFFIC MANAGEMENT USING HEAT MAPS WITH ACTUAL AND PLANNED /ESTIMATED METRICS

(71) Applicant: Cisco Technology, Inc., San Jose, CA (US)

(72) Inventors: Karthik Kulkarni, San Jose, CA (US); Raghunath Nambiar, San Ramon, CA (US)

(21) Appl. No.: 14/327,385

(22) Filed: Jul. 9, 2014

(51) Int. Cl. H04L 12/24; H04L 12/26

(52) U.S. Cl. CPC H04L 41/22; H04L 41/065; H04L 43/06

(57) ABSTRACT

The subject technology provides a single drillable time-series heat map, which combines information of separate network element (e.g., switch, router, server or storage) and relates them together through impact zones to correlate network wide events and the potential impact on the other units in the network. The subject technology also brings together the network and its components (storage, ToR switches, servers, switches, etc.), the distributed application(s) and a heat map controller to proactively communicate with one another to quickly disseminate information such as failures, timeouts, new jobs, etc. Such communication ensures a more predictive picture of the network and enable better adaptive scheduling and routing, which may result in better utilization of resources. The subject technology uses impact zones to make better decisions to place data in the network, and measures network utilization through “Planned Metrics” to provide more realistic usage of network.

### BACKGROUND

Data centers employ various services (aka applications). Such services often demand readily available, reliable, and secure networks and other facilities, such as servers and storage. Highly available, redundant, and scalable data networks are particularly important for data centers that host business critical and mission critical services.

Data centers are used to provide computing services to one or more users such as business entities, etc. The data center may include computing elements such as server computers and storage systems that run one or more services (dozens and even hundreds of services are not uncommon). The data center workload at any given time reflects the amount of resources necessary to provide one or more services. The workload is helpful in adjusting the allocation of resources at any given time and in planning for future resource allocation planning

### BRIEF DESCRIPTION OF THE DRAWINGS

The embodiments of the present technology will hereinafter be described in conjunction with the appended drawings, provided to illustrate and not to limit the technology, wherein like designations denote like elements, and in which:

FIG. 1 shows an example graphical user interface for displaying a network topology in a data center including several network elements or nodes.

FIG. 2 shows an example graphical user interface for indicating a problem in the network topology of the data center.

FIG. 3 shows an example graphical user interface for indicating an affected network element(s) stemming from a problem or failure of another network element(s).

FIG. 4 illustrates a display of a set of heat maps in accordance with some embodiments of the subject technology.

FIG. 5 illustrates a display of a set of heat maps indicating affected portions of a network topology in accordance with some embodiments of the subject technology.

FIG. 6 illustrates a display of a set of heat maps further indicating affected portions of a network topology in accordance with some embodiments of the subject technology.

FIG. 7 illustrates an example network topology environment including a heat map controller application in accordance with some embodiments of the subject technology.

FIG. 8 illustrates an example process that is executed when a problem or issue is detected in the network (and transmitted to the heat map controller) based on the severity of the alert in accordance with some embodiments of the subject technology.

FIG. 9 illustrates an example network environment including a reverse impact zone in accordance with some embodiments of the subject technology.

FIG. 10 illustrates a logical arrangement of a set of general components of an example computing device.

### DETAILED DESCRIPTION

Systems and methods in accordance with various embodiments of the present disclosure may overcome one or more deficiencies experienced in existing approaches to monitoring network activity and troubleshooting network issues.

### Overview

Embodiments of the subject technology provide for receiving a message indicating a problem at a network element in a network. Responsive to the message, an indication of the problem at the network element is provided for display in a graphical representation of a heat map. Based at least on a location of the network element in the network, a set of adjoining network elements connecting directly to the network element is identified. Each of the set of adjoining network elements is then flagged to indicate inclusion in an impact zone associated with the problem at the network element. A second indication is provided for display in the graphical representation of the heat map of the inclusion of each of the adjoining network elements in the impact zone.

### Description of Example Embodiments

While existing implementations may provide ways to monitor 1) network level metrics (e.g., Rx (received traffic), Tx (transmitted traffic), errors, ports up/down, tail drops, buffer overflows, global routing information, maximum and minimum frame rate, packet forwarding rate, throughput, transactions per second, connections per second, concurrent connections, etc.), 2) server level metrics (e.g., CPU usage, RAM usage, Disk usage, disk failures, ports up/down) and 3) alerts, these metrics are isolated and may not be intuitive for real-time monitoring in a large data-center with hundreds and thousands of servers and switches. Further, it is not intuitive to troubleshoot issues (e.g., to identify the root cause of problems in a data center or a network just at looking at symptom areas as the problem could have originated elsewhere in the data center but the symptoms are seen elsewhere). Thus, there could be a need for more intuitive approach of monitoring and troubleshooting with global and deeper insights.

In some embodiments, three different levels of metrics or network characteristics can be observed from switches, routers and other network elements in a datacenter (or a campus network):
1. Global network metrics, routing metrics, performance metrics and/or alerts;
2. Rack level networking with switching top-of-rack metrics, port level metrics, receive/transmit rate, errors, tail drops, buffer overflows, etc.;
3. Through various components at an individual server level, (for example such as unified computing system) and/or storage level: server/storage hardware performance (CPU, server level networking, RAM, Disks I/O), failures (server level networking, storage up/down)

In a data-center, applications (such as “Big Data” applications) and consequences caused by a node failure may in turn affect the traffic or load on the network system, this is because, a node failure would cause the data being lost to be copied from other nodes to maintain the multiple replication policy of every file generally set in a distributed system. As used herein, the phrase “Big Data” refers to a collection of data or data sets so large and complex that it becomes difficult to process using on-hand database management tools or traditional data processing applications, and the phrase “Big Data applications” refers to applications that handle or process such kind of data or data sets.

The following example scenarios illustrate situations in which improved monitoring and management of networking traffic as provided by the subject technology are applicable. For instance, a big data application (e.g., Hadoop, NoSQL, etc.) may start a job by ingesting 10 TB of data. During the job, a server or disk may fail (leading to copy of the data stored in these nodes). In addition, an expected increase in data traffic predictably at a specific time (e.g., certain scheduled bank operations backing up data, etc.) may affect decisions regarding network traffic management. When any of the aforementioned events or conditions occur, the application has knowledge of where the data is flowing and also an idea of how long the data would be ingested (e.g., based on size and/or bandwidth). However, existing implementations for managing network traffic may be blind or unaware of this type of application level information and if performing routing decisions and further network actions totally ignorant of this information which is available to the applications. The subject technology described herein proposes several approaches in order to fill these deficiencies of existing implementations. Various other functions and advantages are described and suggested below as may be provided in accordance with the various embodiments.

Solely using observed metrics at network elements (e.g., network devices such as switches, routers, servers, storage device, or one or more components of a network device such as one or more network ports of a switch or router, etc.) to indicate “heat” or activity (e.g., utilization, performance and/or a problem at a network element or node) of a network element(s) or device(s) (e.g., switches, routers, servers, storage device, etc.) would likely be an incomplete approach to network monitoring. For instance, observed metrics represent a single snapshot (even if considered over a longer duration) in time with zero awareness as to the likely future utilization if an application(s) that generates data sent through the network is ignored especially when that knowledge is already available with the application as is the case here.

In some typical Big Data scenarios, most utilization of network resources are defined by the applications (e.g., data ingestion due to a new job starting, output of a job finishing, replication due to disk/server failure, etc.). In an example, a network switch A could be graphically represented in a color green to indicate underutilization while a switch B might be graphically represented in a color orange to indicate slight or minor utilization. However, a new job from an application could be ingesting data which would be passing through switch A for the next 30 minutes or more and switch B might not have additional traffic in the near future. Thus, choosing a path through switch A would be a bad decision that could be avoided if the “heat” metrics are measured along with inputs from the application.

Embodiments of the subject technology provide additional information of what is planned/estimated (e.g., in terms of network traffic and resource such as I/O bandwidth, memory, CPU and/or other resource utilization, etc.) on the network and the compute and storage systems with the already available and observed “actual metrics” in order to determine “planned/estimated metrics” for use in improving network and other resource (e.g., input/output, Memory, CPU, etc.) management in a given application (e.g., big data application). The use of “Recursive Impact Zones” as further described herein enables adaptive scheduling/routing of network traffic through the network topology as well as enabling global view for monitoring and troubleshooting network issues in a data center or any large network. The combination of application level intelligence that uses planned/estimated metrics with the observed data/metrics result in more realistic metrics of network traffic in the network.

Another advantage of the subject technology is bringing together in a single drillable time-series heat map, information of separate units (e.g., switch, router, server or storage) and relating them or binding them together through impact zones to correlate network wide events and the potential impact on the other units in the network. This could more clearly indicate the overall health of the datacenter.

The subject technology also brings together the network and its components (storage, ToR switches, servers, routers, etc.), the distributed application(s) and a heat map controller (described further herein) to proactively communicate with one another to quickly disseminate information such as failures, timeouts, new jobs, etc. Such communication ensures a more predictive picture of the network and enable better adaptive scheduling and routing, which may result in better utilization of resources.

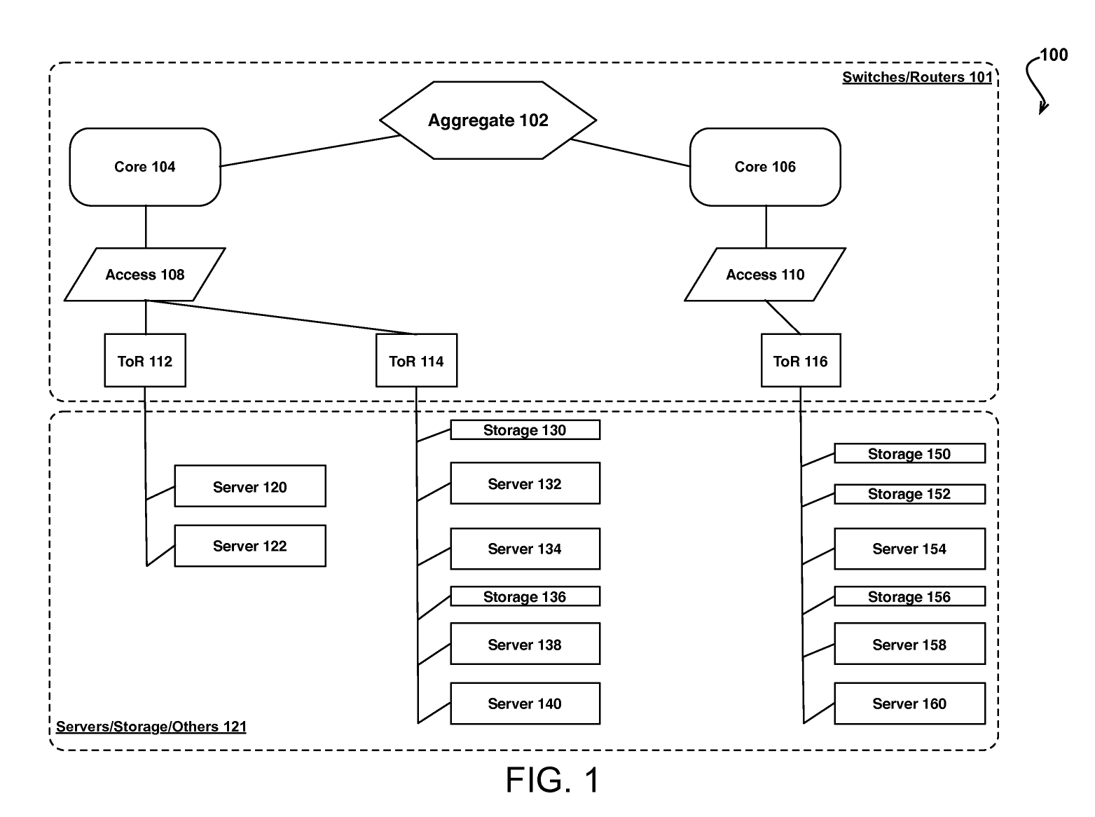

FIG. 1 shows an example graphical user interface 100 (GUI 100) for displaying a network topology in a data center including several network elements or nodes. In the example of FIG. 1, the GUI 100 divides a graphical representation of the network topology into a section 101 for switches and/or routers and a section 121 for servers, storage devices and/or other types of network devices or components. The GUI 100 may be provided by network management application (e.g., a heat-map controller described herein) in at least one example.

As illustrated in FIG. 1, the GUI 100 includes a representation of an aggregation or aggregate switch 102, core switches 104 and 106, and access switches 108 and 110. The aggregate switch 102, in some embodiments, aggregates network traffic from the core switches 104 and 106. The core switch 104 is connected to the access switch 108 and the core switch 106 is connected to access switch 110. Although a particular network topology is illustrated in the example of FIG. 1, it is appreciated that other types of network devices, computing systems or devices may be included and still be within the scope of the subject technology. Further, although the network topology is described herein as including the aggregate switch 102, core switches 104 and 106, and access switches 108 and 110, it is appreciated that embodiments of the subject technology may include routers instead and still be within the scope of the subject technology. For instance, one or more of the switches illustrated in FIG. 1 could be a respective router(s) instead. In some embodiments, the functionality of a switch and a router may be provided in a single network element of the network topology shown in FIG. 1.

In some embodiments, a top-of-rack model defines an architecture in which servers are connected to switches that are located within the same or adjacent racks, and in which these switches are connected to aggregation switches typically using horizontal fiber-optic cabling. In at least one embodiment, a top-of-rack (ToR) switch may provide multiple switch ports that sit on top of a rack including other equipment modules such as servers, storage devices, etc. As used herein, the term “rack” may refer to a frame or enclosure for mounting multiple equipment modules (e.g., a 19-inch rack, a 23-inch rack, or other types of racks with standardized size requirement, etc.). Each ToR switch may be connected to different types of equipment modules as shown in FIG. 1.

As further illustrated, the access switch 108 is connected to a ToR switch 112. The ToR switch 112 is connected to servers 120 and 122. The access switch 108 is connected to a ToR switch 114. The ToR switch 114 is connected to storage device 130, server 132, server 134, storage device 136, server 138 and server 140. The access switch 110 is connected to the ToR switch 116. The ToR switch 116 is connected to storage device 150, storage device 152, server 154, storage device 156, server 158 and server 160.

In at least one embodiment, each representation of network elements shown in FIG. 1 may be displayed in a particular color (e.g., green) to indicate that the corresponding network element is currently operating at a normal status (e.g., without any significant issue(s)).

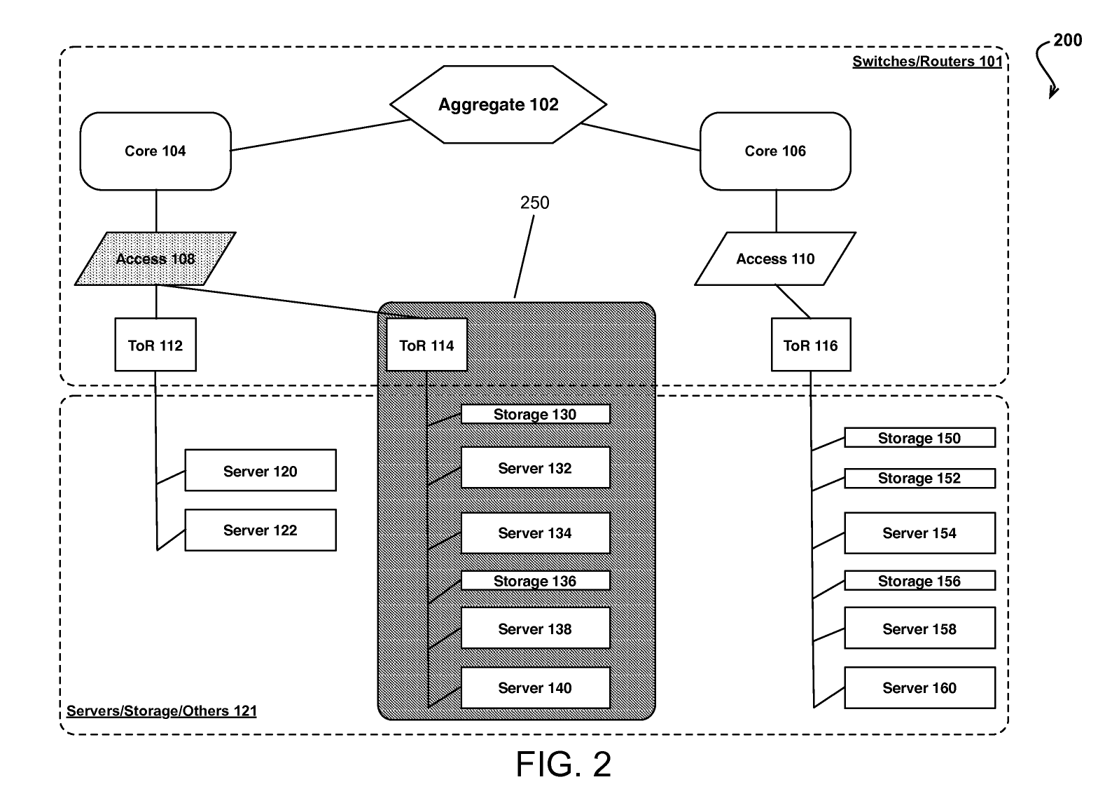

FIG. 2 shows an example graphical user interface 200 (GUI 200) for indicating a problem in the network topology of the data center. The GUI 200 is the same as the GUI 100 but differs in that portions of the network elements are depicted in different ways to indicate a problem or impacted region of the network.

As shown in the example of FIG. 2, the access switch 108 is displayed in a particular color (e.g., red) to indicate that one or more problems are seen at the access switch 108 (for e.g., a particular port went down or is seeing packet drops or buffer overflows). Further, a grayed (or highlighted) section 250 is displayed that indicates a region of the network topology that is impacted from the problem seen at the access switch 108 (this affected network would be directly connected to the problem port as mentioned above). By providing the grayed section 250, the GUI 200 may indicate, in a visual manner, portions of the network topology that are impacted from problems from other network elements in the network topology. A user is therefore able to discover problems in the network topology without performing a lengthy investigation. It should be understood that the grayed section 250 does not necessarily indicate that there will be a failure in that region of the network topology, but a correlation of a potential failure may be determined based at least on the grayed section 250.

The subject technology provides recursive impact zones for monitoring and troubleshooting at one or more points of inspection which will be described in more detail in the following sections.

As used herein, a “point of inspection” is anything (e.g., network element, computing device, server, storage device, etc.) that is being monitored to provide metrics that may change the color or graphical representations of the heat maps. This includes, but is not limited to, the following: 1) switches, routers, servers or storages as a whole (up/down status); 2) network port of a switch (monitoring Tx, Rx, errors, bandwidth, tail drops, etc.); 3) egress or ingress buffer of network ports; 4) CPU or memory of switch or routers (e.g., packets going to CPU that slows the switch); 5) CPU or memory of servers; 6) memory (e.g., errors); 7) disks (e.g., failures), etc.

As used herein, an “impact zone” in a data center or network includes all adjoining network elements (e.g., switches (edge, aggregate, access, etc.), routers, ToR switches, servers, storage, etc.) connecting directly to a network element corresponding to a point of inspection such as a switch, router, server or storage device, etc. Thus, it is understood that an impact zone includes at least a portion of the network topology of a data center or network in at least one embodiment.

A “recursive impact zone,” as used herein, defines a hierarchical impact zone which includes all the further adjoining units connected to an initial point of inspection. For example, suppose a port in the aggregate switch or router goes down. First, this would impact the top-of-rack switch connecting to that port in the aggregate switch, which in turn takes all the servers connected to the top-of-rack out of the network. Consequently, a three (3) level hierarchical impact zone is defined in this example 1) starting from the aggregate switch, 2) continuing to the top-of-rack switch, and 3) then to each server connected to the top-of-rack switch. In contrast, a top-of-rack switch connected to an adjoining port of the same aggregate switch, which is currently up, would not be part of this impact zone as this adjoining port is not affected.

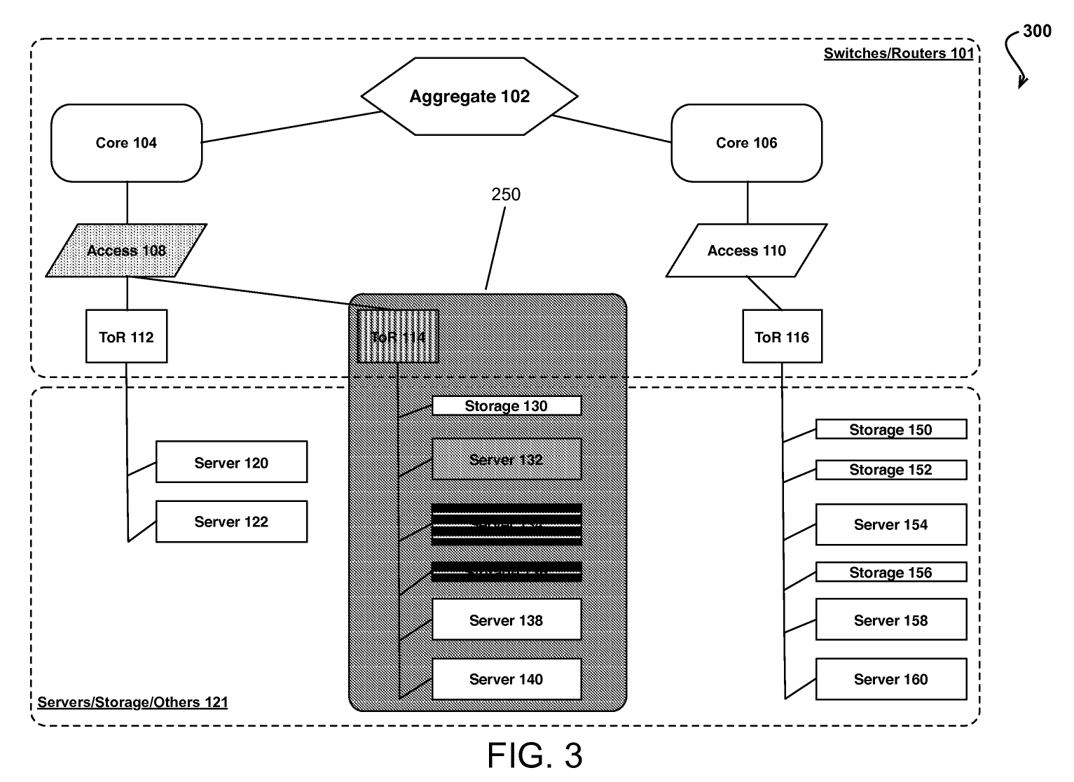

FIG. 3 shows an example graphical user interface 300 (GUI 300) for indicating an affected network element(s) stemming from a problem or failure of another network element(s). The GUI 300 is the same as the GUI 200 but differs in that additional network elements are depicted in further ways to indicate, in a more targeted manner, affected network elements.

As illustrated in FIG. 3, the access switch 108 is indicated in the GUI 300 as having a problem or issue(s) such as a respective port on the access switch 108 being down. Thus, a recursive impact zone in the GUI 300 includes the access switch 108, the ToR switch 114, the storage device 130, the server 132, the server 134, the storage device 136, the server 138 and the server 140. As further indicated, the ToR switch 114 and the server 132 may be depicted in the GUI 300 in a particular color (e.g., orange) to indicate that the ToR switch 114 and the server 132 are in a busy state but do not (yet) exhibit any errors or problems at the time being. The server 134 and the storage device 136 may be graphically indicated in a different color (e.g., red) to indicate that these network elements have issue(s) or problem(s) that have been propagated from the port of the access switch 108 being down. As further shown, the storage device 130, the server 138 and the server 140 are indicated in a different color (e.g., green) to indicate that these network elements are currently operating in a normal state and not affected by the port having problems at the access switch 108.

It is appreciated that other types of graphical representations to indicate normal, busy, or problem status (or any other status) at each of the network elements in the network topology may be used and still be within the scope of the subject technology. By way of example, such other types of graphical representations may include not only other colors, but patterns, highlighting, shading, icons, or any other graphical indication type.

In some embodiments, the subject technology provides a heat map (or “heatmap” or “heat-map” as used herein), which is a graphical representation of data in a matrix (a set of respective cells or blocks) where values associated with cells or blocks in the matrix are represented as respective colors. Each cell in the matrix refers to a router or switch or a server (with or without storage), a storage unit or storage device or other IP device (e.g., IP camera, etc.). The heat (represented by a color(s) ranging from green to orange to red) in the matrix indicates the overall health and performance or usage of the network, server, storage unit or device. As the usage is low or the unit is free, and there are no alerts or failures, the cell is green colored and as the units usage is reaching thresholds or if it has a failure or errors, the cell gets closer to a red color. In some embodiments, a color such as orange indicates the system is busy but has not reached its threshold.

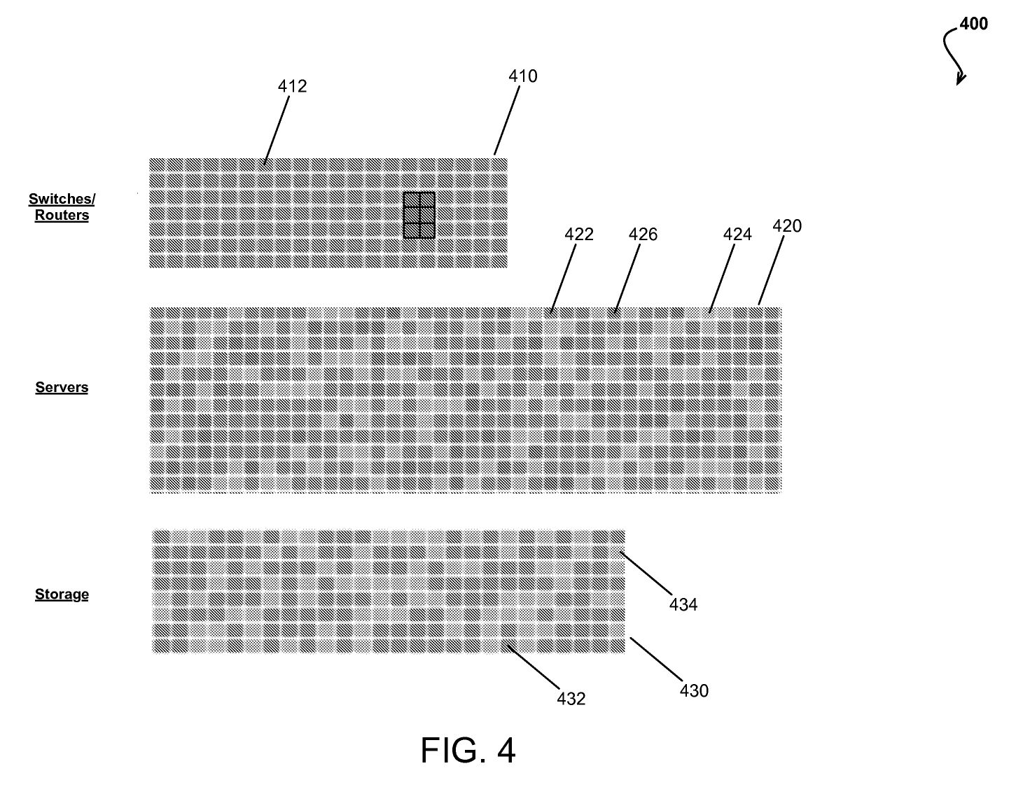

FIG. 4 illustrates a display 400 of a set of heat maps in accordance with some embodiments of the subject technology. The display 400 may be provided in a GUI as part of a heat-map controller application as further described herein.

As illustrated, the display 400 includes heat map 410, heat map 420 and heat map 430. Each heat map represents a respective level in a hierarchy of network elements in a network topology. For instance, the heat map 410 corresponds to switches and routers, the heat map 420 corresponds to servers, and the heat map 430 corresponds to storage devices. Although three levels of network elements are illustrated in the example of FIG. 4, it is appreciated that more or less numbers of levels may be included to represent other types of network elements.

As discussed before, each heat map provides a graphical representation of data in a matrix, including respective cells or blocks, where values associated with cells or blocks in the matrix are represented as one or more colors. The color assigned to a cell in the matrix indicates the overall health and performance or usage of the network, server or storage device. For example, cells 412, 422 and 432 are assigned a green color to indicate that the respective usage of the corresponding network elements is low and there are no alerts or failures. Cells 424 and 434 are assigned an orange color indicating that the corresponding network elements are busy but have not reached a threshold usage level. Cell 426 is assigned a red color to indicate that the corresponding network element is reaching a threshold usage level or that the network element has a failure or error(s).

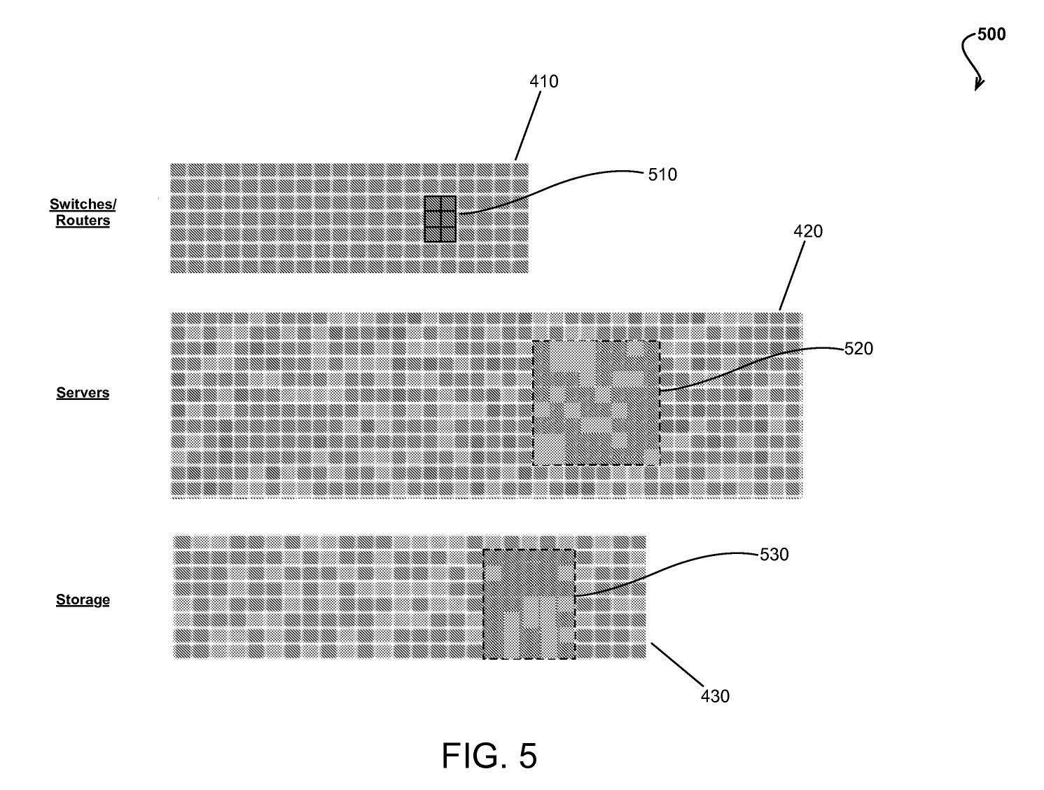

FIG. 5 illustrates a display 500 of a set of heat maps indicating affected portions of a network topology in accordance with some embodiments of the subject technology. The display 500 may be provided in a GUI as part of a heat-map controller application as further described herein. The display 500 is similar to the display 400 in FIG. 4 with the addition of other graphical elements to indicate impact zones and highlight problem in portions of the network topology.

In some embodiments, the heat maps shown in FIG. 5 may be implemented as drillable heat maps. As used herein, a “drillable” heat map adds a time dimension to a traditional 2D heat map. These matrix cells can be clicked on (e.g., drilled into), to reveal time series information on the historic metrics. Such time series information may be in the form of a graph in which data corresponding to a respective metric is graphed over time.

As discussed before, the heat maps may correspond to respective network elements such as switches, routers, top-of-rack switches, servers or storage devices (or other network appliances). Each of the aforementioned network elements may be intelligently monitored on a single window (e.g., “pane”) or graphical display screen through drillable heat maps with time series information. Further, drilling or selecting red matrix cells can pinpoint in a time series when a problem or issue occurred.

As illustrated, red section 510 indicates a problem seen in respective switches or routers corresponding to the cells included in red section 510. A grayed section 520 represents an impact zone in servers and a grayed section 530 represents an impact zone in storage devices. In some embodiments, impact zones can determined based at least in part on information from using the Neighbor Discovery Protocol (NDP) and through manual configurations that form a logical dependency graph.

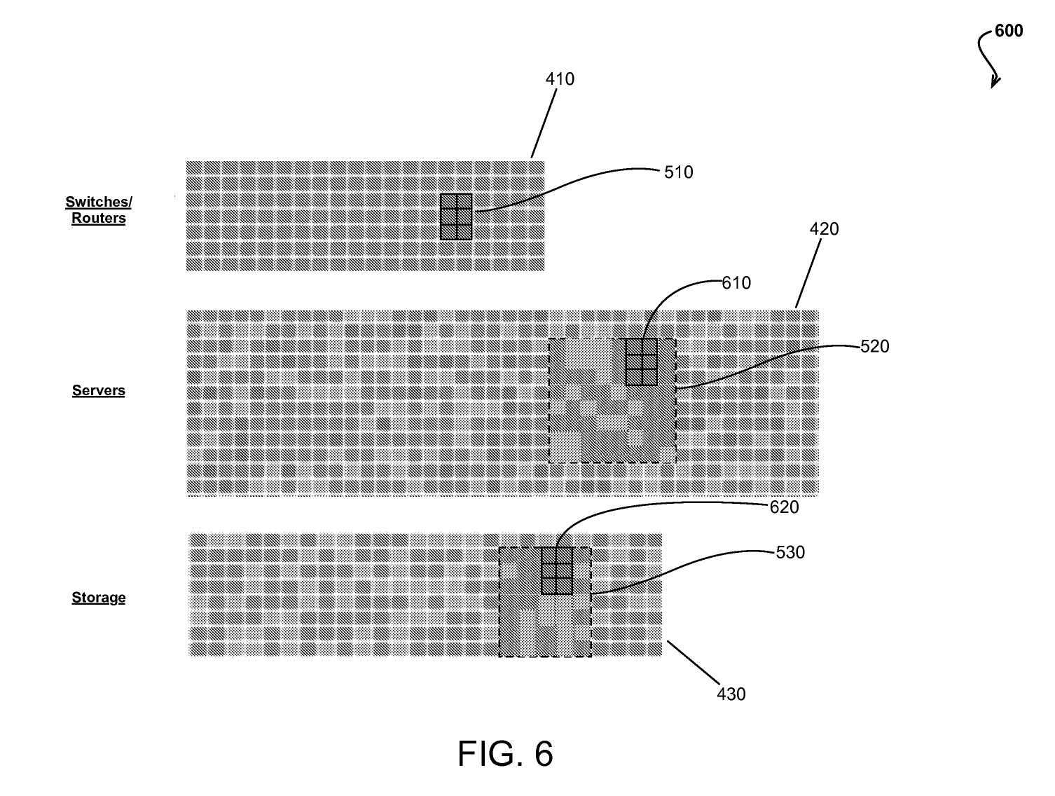

FIG. 6 illustrates a display 600 of a set of heat maps further indicating affected portions of a network topology in accordance with some embodiments of the subject technology. The display 600 may be provided in a GUI as part of a heat-map controller application as further described herein. The display 600 is similar to the displays 400 and 500 in FIGS. 4 and 5 with the addition of other graphical elements to indicate impact zones and highlight problem in portions of the network topology.

In some configurations, a user may provide input to (e.g., hover over) the red section 510 to determine which portions of the network topology that are affected by an error or failure of switches or routers corresponding to the cells in the red section 510. As shown, a red section 610 indicates servers that are affected by the problems from the switches or routers associated with cells from the red section 510. Further, it is seen that a red section 620 indicates storage devices that are affected by the problems from the switches or routers associated with cells from the red section 510. In some embodiments, the heat maps shown in FIG. 6 may be implemented as drillable heat maps.

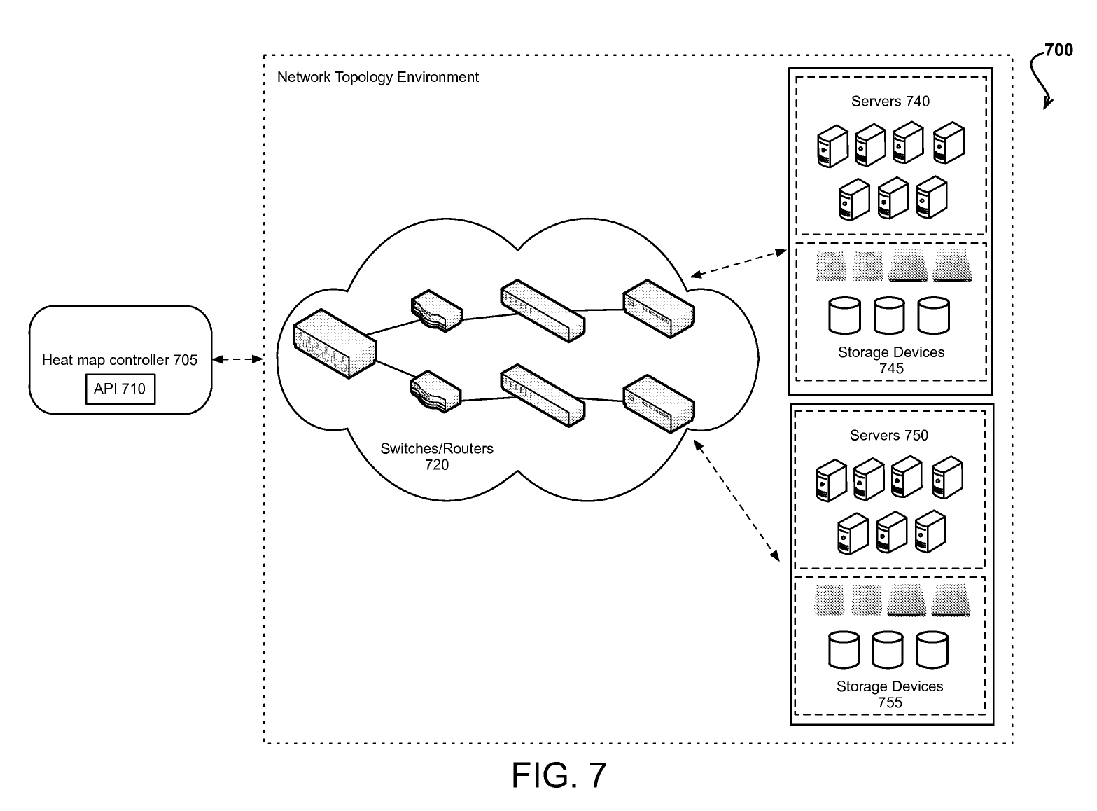

FIG. 7 illustrates an example network topology environment 700 including a heat map controller application in accordance with some embodiments of the subject technology.

As illustrated, a heat map controller 705 is provided. In at least one embodiment, the heat map controller 705 is implemented as an application that each network element in a network topology environment periodically communicates with to provide one or more metrics. The heat map controller 705 communicates with the network elements to exchange information and has the most current consolidated information of the network in its database. By way of example, the heat-map controller may be implemented as part of a SDN (Software-Defined Network) application or part of a Hadoop Framework using technologies such as (but not limited to) OpenFlow, SNMP (Simple Network Management Protocol), OnePK (One Platform Kit) and/or other messaging APIs for communication with network elements to receive information related to metrics. In some embodiments, communication between the heat map controller 705 and network elements could be initiated from the network element to the heat map controller 705 based on application events, or hardware events as explained further below. As shown, the heat map controller 705 may include an API 710 that enables one or more network elements such as switches or routers 720, servers 740 and 750, and storage devices 745 and 755 to make API calls (e.g., in a form of requests, messaging transmissions, etc.) to communicate information regarding metrics to the heat map controller 705.

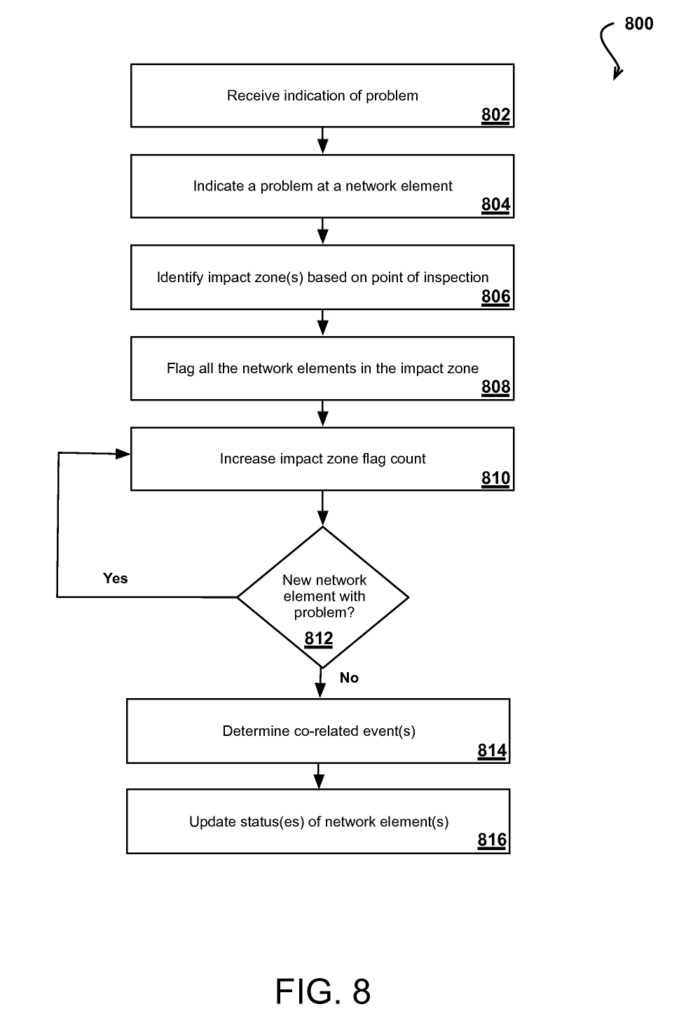

FIG. 8 illustrates an example process 800 that is executed when a problem or issue is detected in the network (e.g., failures, errors or timeouts, etc.) and transmitted to the heat map controller, based on the severity of the alert (e.g., network not reachable, performance issues, packet drops, over utilization, etc.) in accordance with some embodiments of the subject technology. The process 800, in at least one embodiment, may be performed by a computing device or system running the heat map controller in order to update one or more graphical displays of respective heat maps for different levels of the network topology.

At step 802, an indication of a problem or issue is received by the heat map controller. At step 804, the heat-map controller indicates a problem at a network element(s) by showing red for the corresponding cell (e.g., as in FIGS. 5 and 6) in the heat map or for a graphical representation of the network element (e.g., as in FIGS. 2 and 3). At step 806, the heat map controller identifies “recursive impact zone” based on the point of inspection. As discussed before, the impact zone includes all adjoining network elements (e.g., switches (edge, aggregate, access, etc.), routers, ToR switches, servers, storage, etc.) connecting directly to a network element corresponding to a point of inspection such as a switch, router, server or storage device, etc. Recursive impact zone may include all the network elements attached to the immediate affected network elements in a recursion or loop all the way to the edge to include all network elements in the impacted zone.

At step 808, the heat-map controller flags each network element corresponding to respective cells (or graphical representations) in the impact zone. An initial impact zone flag count is set to a number of network elements in the impact zone. Further, the heat-map controller indicates, by graying or dulling the color in the impact zone, to suggest that other network elements in the impact zone that currently are indicated in green (e.g., as being healthy or without problems), that these other network elements might not be reachable or have network bandwidth/reachability issues higher up at the network level hierarchy or could exhibit other issues.

At step 810, each time a new network element is discovered in an impact zone as having a problem(s) due to some alert, an impact zone flag count is increased to indicate multiple levels of issues to reach the network element. This impact zone flag value in turn decides how many other cells corresponding to other network elements or graphical representations of such network elements are made dull or gray.

At step 812, if a new network element within the impact zone actively shows red as indicating a problem, this would suggest that there could be a related event or events further up in hierarchy within the network that could be the root-cause of this issue. The impact zone for this node is again calculated and the impact zone flag is incremented as explained in step 810.

At step 814, the heat map controller determines one or more co-related events. By way of example, if an event matches a corresponding related event in a co-related events map (e.g., as shown below) in the above hierarchy, then this event could be specially colored to indicate that it is likely that the two events are related.

As used herein, a “co-related events map” refers to a modifiable list of potential symptoms caused by events. For example, a port up/down event on an aggregate switch can cause port flapping (e.g., a port continually going up and down) on the connected switch or router. This sample list will be used to co-relate events to troubleshoot problems:

| Event | Co-related event |
|---|---|
| Port up/down | Link flap |
| Egress buffer overflow | Ingress buffer overflow (TCP incast issues, |
| | top-of-rack egress buffer overflow and |
| | underlying server ingress buffer overflow) |
| High CPU | Network Timeout events (copy to CPU on |
| | switches not controlled could lead to other |
| | network timeouts) |

At step 816, since alerts are dynamic in some embodiments, the next message or alert received by the heat map controller could clear an alarm or show the system is healthy. Thus, when receiving a message indicating that a particular network element is back to healthy status, the heat map controller may update the status of this network element accordingly (e.g., indicating green corresponding to the network element in a heat map).

In this manner, if an application system wishes to actively probe the network to identify network health or potential routes or choose between servers, this updated heat map with one or more impact zones can better provide the result. Moreover, with information related to impact zone(s), two different servers indicated as being healthy (e.g., green) could be distinguished so as to identify one server in an impact zone that prevents higher bandwidth to reach this identified server.

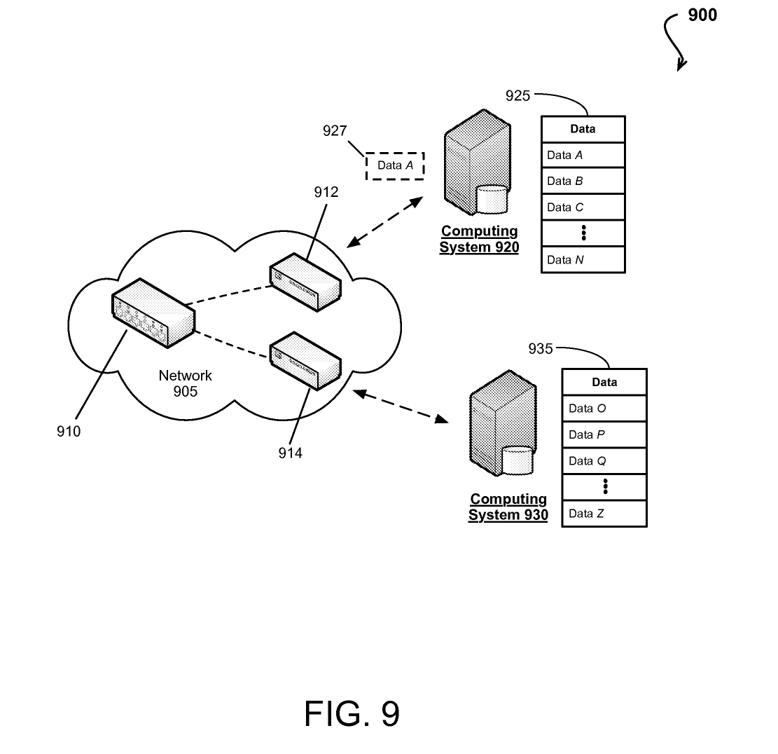

FIG. 9 illustrates an example network environment 900 including a reverse impact zone in accordance with some embodiments of the subject technology.

As used herein, a reverse impact zone is mostly defined bottom up (e.g., origination from edge to the core). In one example of FIG. 9, suppose a server corresponding to computing system 920, including a set of data 925 in storage, needs to send data 927 to another server corresponding to computing system 930, including a set of data 935 in storage, in the same rack of a network 905, the reverse impact zone can be defined as including a path where the data 927 has to go to a ToR switch 912 of the computing system 920 and then be forwarded to the computing system 930 if local switching is available. In this example, the reverse impact zone includes the ToR switch 912 which has to transport or carry the data.

In another example of FIG. 9, if the ToR switch 912 does not support local switching or if the computing system 930 is located in another rack, then the data 927 has to be forwarded to another router or an aggregate switch 910 before it is forwarded to a ToR switch 914 of the computing system 930 and then to the computing system 930. In this example, the reverse impact zone includes ToR switch 912 of the computing system 920, the aggregate switch 910 and the ToR switch 914 for the computing system 930.

The communication between an application(s), network element and heat map controller follows an “adaptive networking communication protocol” as further described below. In this regard, a network element (e.g., router, switch, storage, server, IP camera, etc.) periodically pushes data to the heat map controller to provide data (metrics) to publish as heat maps.

Other forms of communication include the following:

(1) Initiated by network element (e.g., switch, server, storage or other network device, etc.) or an application running on the network element:
a. If the server sees a disk(s) failure or the switch sees a server down, or even if an aggregate switch sees a ToR switch down (e.g., unreachable or rack-failure), this information of all affected units in an impact zone is messaged over to the heat map controller.
b. The heat-map controller forwards this message to the application (e.g., Hadoop or any other distributed application).
c. The application identifies which data-set(s) are lost.
d. The application identifies where are the other replicas in the cluster from which another copy can be created.
e. The application identifies where all the copies for these replicas should be placed based on the scheduler logic without considering the network into picture with all potential alternatives.
f. The application messages this information of list of all potential (chosen initially based on application logic of pruning some nodes as not fit) source replica from where an additional copy is initiated from and destination replica, to which a new replica will be copied to, to the heat map controller.

An example is described in the following:

Copy block A, B, C from the following locations:

| Blocks | Source | Destination | Copies | Pipelined |
|---|---|---|---|---|
| A | x, y | d, e, f | 2 | 1 |
| B | m | n, p | 1 | 1 |
| C | i, j | k, l | 1 | 1 |

In the first row above, block A is copied from either network elements x or y to either network elements d or e or f. If pipelined and number of copies is more than 1 then, after the first copy, follow with another copy from a network element that is initially chosen to any other network elements remaining in the destination.
g. The heat map controller places this information in an incoming queue of requests (could be multiple-queue based on priority of request e.g.: A request made by CEO is placed in a higher priority queue than a request coming from a test job or experimental job), the queues could also be reordered based on aging in individual queues based on retries.
h. Considering example above, first line, once a request is accepted for processing from the queue, this would trigger the Heat-map controller to identify the reverse impact zones for copying from network element x to network element d, network element x to network element e, network element x to network element f and network element y to network element d, network element y to network element e and network element y to network element f and choosing one of those, say network element “d”, check a reverse impact zone for network element d to network element e and network element d to network element f to finalize on a suggested placement (if pipelined) based on how it would impact the heat metric on the nodes of the reverse-impacted zone. The controller has to iterate through all combinations to find the best placement based on the heat-map suggestion and whether replica placement is pipelined (e.g., network element x copies to network element d and then network element d copies to network element e (or network element f))

This could result in a response such as the following from the heat-map controller if the copy is pipelined or concurrent based on the application framework (Hadoop is pipelined, others could be concurrent).

(pipelined)

| Block | Source | Destination | Pipelined |
|---|---|---|---|
| A | x | d | 1 |
| A | d | e | 1 |

(concurrent)

| Block | Source | Destination | Pipelined |
|---|---|---|---|
| A | x | d | 0 |
| A | y | e | 0 |

i. The heat map controller verifies if the suggested source and replica placement would be best fit given the jobs demand (no new higher priority job request) and network/resource availability and updates the heat-metrics (both utilization and duration) with the final list while maintaining changes made for this specific job id and time (needed in case a job is cancelled or killed, then the metrics need to be freed up or refreshed based on the routes). The heat map controller sends this list to the application.
j. The applications 1) starts the copies after waiting for the default wait period (if needed based on application logic) or 2) starts the replication right away.

(2) Initiated by Distributed Application (Hadoop like distributed application)
a. If the application starts a new job by ingesting data, the application is aware of the size of the data and the splits of the file and same as steps from (e) to (j) of (1) described above are performed.

(3) Initiated by Heat-Map controller
a. This is similar to (1) described above, if a server doesn't respond even if it looks healthy from a heat maps point of view due to any application specific reasons, i.e., if the server hosting data times out from the distributed application point of view, then after a default elapsed time, the data is deemed lost or a disk failure is indicated.
b. Repeat the same steps from (c) to (j) of (1) above

By following the approach, the network, application and heat-map controller have proactively updated the heat in the heat-map and application has indirectly become network aware. Any next event will be based on this current state of the updated heat-map, and if a new replica has to be placed, the negotiation would ensure to pick up a reverse impact zone which is less “hotter” to ensure better network performance. The routing protocol could pick up these updated heat maps to adapt to the changing network usage to provide different routes.

The following discussion relates to actual and planned/estimated metric(s) as used by the subject technology. In some embodiments, metrics may be calculated by reverse impact zones through application awareness: the network element (e.g., router, switch, storage device, server, IP camera, etc.) periodically pushes data to the heat-map controller to gather data (metrics) to publish as heat maps. This forms the base metrics as these are observed, which are considered the “actual metrics.”

To identify more useful “planned metrics,” the following approaches may be used. In a big data deployment scenario in a datacenter, the following main events (e.g., controlled and uncontrolled) trigger application to ingest data within a network.

Similarly as done for a network utilization heat score, a heat score is added for the I/O utilization for the server/storage whenever data is being copied to or from a node. The I/O (e.g., for input/output storage access) utilization score may be dependent on the size of the data being copied. As servers are selected to place data on the servers or copy data from the servers, this burns I/O bandwidth available on those servers and consumes available storage. Hence, this can be estimated as a heat score against the metric (e.g., I/O) based on the data size being copied and the available I/O bandwidth may be estimated (e.g., copying 1 TB to a 4 TB size drive with 100 MBps I/O bandwidth takes 10000 seconds which is 167 minutes or 2 hours and 47 minutes). Copying of data leads to CPU and memory utilization and, thus, a small delta or amount can be added to the heat score for CPU and memory utilization on those systems (e.g., the server and/or storage where data is copied from and copied to) to provide the planned/estimated metric.

### Controlled

a) New job, ingesting input data (and for replication)
b) Periodic and controlled backups or periodic data ingestion at regular hours

### Uncontrolled

c) Disk or Server failure, prompting the application to copy the data again or replicate the data
d) The application job creating lots of data during execution (e.g., a web crawler downloading the webpages from links)

The application has to decide where the data is going to be placed through splits, and the application is aware as to how much data needs to be copied. While the application can choose or is aware of the servers where the data is going to be copied from and copied into, this information can be communicated with the heat map controller. In this regard, the heat map controller through reverse impact zones can identify switches and ports which are going to carry the network traffic. Each time a switch carries the traffic, a heat score for that switch/router and port is increased relative to its bandwidth and size for the potential time it could take. The switch/router would expect a higher utilization for specific time intervals based on the data provided by the application. The switch/router periodically monitors the utilization for the expected utilization every few seconds (can be tuned). The heat score can be reduced when the application informs the copy job is completed or when the observed utilization begins to drop (for few consecutive checks) to consider timeouts. The heat score is also reduced if a copy job is cancelled in between and the application informs that the copy job is cancelled. This provides a heat score to easily compare what to expect to happen in different sections of the network for the next few minutes to hours.

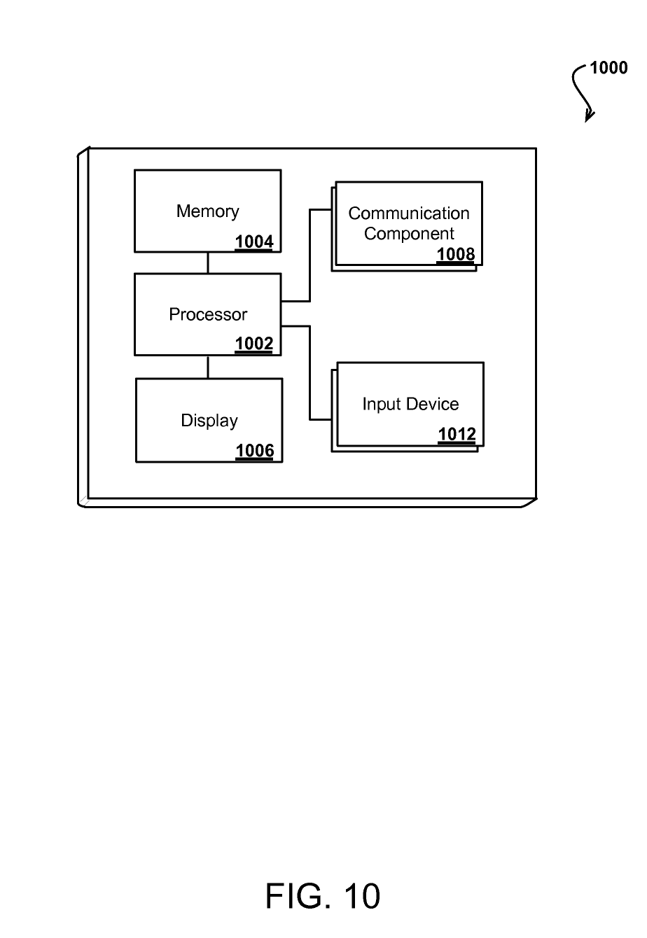

FIG. 10 illustrates a logical arrangement of a set of general components of an example computing device 1000. In this example, the device includes a processor 1002 for executing instructions that can be stored in a memory device or element 1004. As would be apparent to one of ordinary skill in the art, the device can include many types of memory, data storage, or non-transitory computer-readable storage media, such as a first data storage for program instructions for execution by the processor 1002, a separate storage for images or data, a removable memory for sharing information with other devices, etc. The device typically will include some type of display element 1006, such as a touch screen or liquid crystal display (LCD), although devices such as portable media players might convey information via other means, such as through audio speakers. As discussed, the device in many embodiments will include at least one input element 1012 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 1000 of FIG. 10 can include one or more communication components 1008, such as a Wi-Fi, Bluetooth, RF, wired, or wireless communication system. The device in many embodiments can communicate with a network, such as the Internet, and may be able to communicate with other such devices

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, SAP ®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”). Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and other non-transitory computer readable media for containing code, or portions of code, can include any appropriate storage media used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system, comprising:
at least one processor; and
memory including instructions that, when executed by the at least one processor, cause the system to:
receive a message indicating a problem at a network element in a network;
responsive to the message, provide, for display, an indication of the problem at the network element in a graphical representation of a heat map;
identify, based at least on a location of the network element in the network, a set of adjoining network elements connecting directly to the network element;
flag each of the set of adjoining network elements to indicate inclusion in an impact zone associated with the problem at the network element; and
provide, for display, a second indication in the graphical representation of the heat map of the inclusion of each of the adjoining network elements in the impact zone.

2. The system of claim 1, wherein the graphical representation of the heat map comprises a set of cells, each cell from the set of cells corresponding to a respective network element in the network.

3. The system of claim 2, wherein to provide the indication of the problem at the network element comprises:
indicating a cell from the set of cells of the heat map in a red color.

4. The system of claim 2, wherein to provide the second indication of the inclusion of each of the adjoining network elements in the impact zone comprises:
indicating a plurality of cells from the set of cells of the heat map in a gray color.

5. The system of claim 1, wherein the instructions further cause the at least one processor to:
increase an impact zone flag count based on the flagged set of adjoining network elements;
determine if a new network element in the impact zone has been indicated as having a problem; and
increase the impact zone flag count based on the new network element.

6. The system of claim 1, wherein the instructions further cause the at least one processor to:
determine one or more co-related events based on the problem at the network element.

7. The system of claim 1, wherein the instructions further cause the at least one processor to:
receive a second message indicating that the problem at the network element has been resolved; and
responsive to the second message, provide, for display, a respective indication of the network element as being in a healthy status in the graphical representation of the heat map.

8. A computer-implemented method, comprising:
receiving a message indicating a problem at a network element in a network;
responsive to the message, providing, for display, an indication of the problem at the network element in a graphical representation of a heat map;
identifying, based at least on a location of the network element in the network, a set of adjoining network elements connecting directly to the network element;
flagging each of the set of adjoining network elements to indicate inclusion in an impact zone associated with the problem at the network element; and
providing, for display, a second indication in the graphical representation of the heat map of the inclusion of each of the adjoining network elements in the impact zone.

9. The computer-implemented method of claim 8, wherein the graphical representation of the heat map comprises a set of cells, each cell from the set of cells corresponding to a respective network element in the network.

10. The computer-implemented method of claim 9, wherein to provide the indication of the problem at the network element comprises:
indicating a cell from the set of cells of the heat map in a red color.

11. The computer-implemented method of claim 9, wherein to provide the second indication of the inclusion of each of the adjoining network elements in the impact zone comprises:
indicating a plurality of cells from the set of cells of the heat map in a gray color.

12. The computer-implemented method of claim 8, further comprising:
increasing an impact zone flag count based on the flagged set of adjoining network elements;
determining if a new network element in the impact zone has been indicated as having a problem; and
increasing the impact zone flag count based on the new network element.

13. The computer-implemented method of claim 8, further comprising:
determining one or more co-related events based on the problem at the network element.

14. The computer-implemented method of claim 8, further comprising:
receiving a second message indicating that the problem at the network element has been resolved; and
responsive to the second message, providing, for display, a respective indication of the network element as being in a healthy status in the graphical representation of the heat map.

15. A non-transitory computer-readable medium including instructions stored therein that, when executed by at least one computing device, cause the at least one computing device to:
receive a message indicating a problem at a network element in a network;
responsive to the message, provide, for display, an indication of the problem at the network element in a graphical representation of a heat map;
identify, based at least on a location of the network element in the network, a set of adjoining network elements connecting directly to the network element;
flag each of the set of adjoining network elements to indicate inclusion in an impact zone associated with the problem at the network element; and
provide, for display, a second indication in the graphical representation of the heat map of the inclusion of each of the adjoining network elements in the impact zone.

16. The non-transitory computer-readable medium of claim 15, wherein the graphical representation of the heat map comprises a set of cells, each cell from the set of cells corresponding to a respective network element in the network.

17. The non-transitory computer-readable medium of claim 16, wherein to provide the indication of the problem at the network element comprises:
indicating a cell from the set of cells of the heat map in a red color.

18. The non-transitory computer-readable medium of claim 16, wherein to provide the second indication of the inclusion of each of the adjoining network elements in the impact zone comprises:
indicating a plurality of cells from the set of cells of the heat map in a gray color.

19. The non-transitory computer-readable medium of claim 15, wherein the instructions further cause the at least one computing device:
increase an impact zone flag count based on the flagged set of adjoining network elements;
determine if a new network element in the impact zone has been indicated as having a problem; and
increase the impact zone flag count based on the new network element.

20. The non-transitory computer-readable medium of claim 15, wherein the instructions further cause the at least one computing device:
determine one or more co-related events based on the problem at the network element.

21. The non-transitory computer-readable medium of claim 15, further comprising:
receiving event information related to uncontrolled events or controlled events that occur in the network or input/output (I/O) or memory or CPU, the uncontrolled events including at least one of a disk or server failure or an application job creating data during execution, the controlled events including at least one of a new application job, a periodic backup or a periodic data ingestion event;
determining, based on at least the uncontrolled events or the controlled events, a set of planned or estimated metrics, the set of planned or estimated metrics comprising information related to future network or I/O or memory or CPU activity of at least one respective network element, the future network or I/O or memory or CPU activity indicating a higher utilization of the at least one respective network element during a future time interval; and
adjusting a heat score of the at least one respective network element based on the set of planned metrics.

22. The non-transitory computer-readable medium of claim 15, further comprising:
selecting a request from a queue of requests, the request including information for copying a set of data from a first network element from a set of first network elements to a second network element from a set of second network elements and information for replicating the set of data copied to the second network element to a third network element from the set of second network elements;
identifying, based on the information, a reverse impact zone for copying the set of data from the first network element to the second network element and for replicating the set of data copied to the second network element to the third network element;
receiving information indicating that the third network element has initiated a higher priority job than replicating the set of data; and
using heat-map information related to the reverse impact zone to select a fourth network element from the second set of network elements for replicating the set of data copied to the second network element, the fourth network element having a lower heat score than the third network element.
